(19) United States
(12) Patent Application Publication
(10) Pub. No.: US 2023/0314363 A1
(43) Pub. Date: Oct. 5, 2023

(54) SENSOR ELEMENT AND GAS SENSOR

(71) Applicant: NGK INSULATORS, LTD., Nagoya-shi (JP)

(72) Inventors: Shotaro NIIZUMA, Kasugai-shi (JP); Yusuke WATANABE, Nagoya-shi (JP); Toshihiro HIRAKAWA, Kasugai-shi (JP); Kirari TAKAHASHI, Ikeda-cho (JP)

(21) Appl. No.: 18/185,607

(22) Filed: Mar. 17, 2023

(30) Foreign Application Priority Data
Mar. 30, 2022 (JP) 2022-056676

(51) Int. Cl. G01N 27/407

(52) U.S. Cl. CPC G01N 27/4077

(57) ABSTRACT

A sensor element includes: an element body that includes a base part in an elongated plate shape and a measurement-object gas flow part; and a porous protective layer that is formed from one end and covers at least a part in the longitudinal direction of a surface of the element body. The protective layer include: an inner layer; and an outer layer covering the inner layer and a region where the inner layer is not formed. On one principal surface in a region where the inner layer is formed, a first space exists in at least a part between the inner and outer layers, and on the one principal surface in a region where the inner layer is not formed on the one principal surface on which the first space exists, a second space exists in at least a part between the one principal surface and the outer layer.

### CROSS-REFERENCE TO RELATED APPLICATION

The present application claims priority from Japanese application JP2022-056676, filed on Mar. 30, 2022, the contents of which is hereby incorporated by reference into this application.

### BACKGROUND OF THE INVENTION

### Technical Field of the Invention

The present invention relates to a sensor element and a gas sensor for detecting a target gas to be measured in a measurement-object gas.

### Background Art

A gas sensor is used for detection or measurement of concentration of an objective gas component (oxygen O₂, nitrogen oxide NOx, ammonia NH₃, hydrocarbon HC, carbon dioxide CO₂, etc.) in a measurement-object gas, such as exhaust gas of automobile. As such a gas sensor, a gas sensor which has a sensor element using an oxygen ion conductive solid electrolyte such as zirconia (ZrO₂) is known.

It is known that in such a gas sensor, a porous protective layer is formed on the surface of the sensor element for the purpose of preventing the occurrence of cracking in the internal structure of the sensor element due to thermal shock resulting from the attachment of moisture to the sensor element. Further, for example, JP 2015-087161 A and JP 2020-020738 A disclose embodiments in which a space is provided between a protective layer and a base body of a sensor element.

### CITATION LIST

### Patent Documents

Patent Document 1: JP 2015-087161 A
Patent Document 2: JP 2020-020738 A
Patent Document 3: JP 2016-090569 A
Patent Document 4: JP 2021-060219 A

### SUMMARY OF THE INVENTION

### Problems to be Solved by the Invention

The sensor element has a high temperature (e.g., about 800° C.) when the gas sensor performs measurement of a target gas to be measured. There is a problem that when moisture attaches to such a sensor element having a high temperature, cracking occurs in an internal structure of the sensor element due to the thermal shock.

Due to the tightening of automobile emission regulations, a gas sensor that enables early start-up is required for reducing emissions at engine starting. That is, a gas sensor installed in an automobile is required to start to measure a target gas to be measured in exhaust gas just after starting of an automotive engine. Just after engine starting, a larger amount of condensed water is present in exhaust pipes. Therefore, there is a higher risk that water is splashed on a sensor element having a high temperature. As a result, there is a higher risk that cracking occurs in an internal structure of the sensor element due to the thermal shock resulting from the attachment of moisture to the sensor element.

Under such circumstances, the sensor element having a high temperature is required to further suppress the occurrence of cracking in its internal structure due to exposure to water (water splash). That is, it is required to further improve the water resistance of the sensor element.

For example, JP 2015-087161 A mentioned above discloses a sensor element including a porous protective layer provided on a surface thereof, wherein a space exists between vertexes of an element body and the protective layer. Further, J P 2020-020738 A mentioned above discloses that a porous protective layer is formed on a surface of a sensor element with a thermal insulating space being interposed between them. Such a protective layer is required to have a thermal capacity sufficient to reduce thermal shock to the element body. Further, the protective layer is required to sufficiently withstand physical shock caused by vibration and thermal shock caused by water adhesion during the use of the gas sensor.

In light of this, it is an object of the present invention to provide a sensor element and a gas sensor having higher water resistance.

### Means for Solving the Problems

The present inventors have intensively studied and as a result have found that the water resistance of a sensor element is improved by forming a porous protective layer on at least a part of a surface of an element body, providing a space inside the protective layer (interposing a space between an inner layer and an outer layer of the protective layer) as will be described below, and interposing a space between the element body and the protective layer as will be described below. That is, in the present invention, the protective layer is in the form of a complex protective layer.

The present invention includes the following aspects.

(1) A sensor element for detecting a target gas to be measured in a measurement-object gas, the sensor element comprising:
an element body that includes a base part in an elongated plate shape, including an oxygen-ion-conductive solid electrolyte layer, and a measurement-object gas flow part formed on a side of one end in a longitudinal direction of the base part; and
a porous protective layer that is formed from the one end in the longitudinal direction of the base part and covers at least a part in the longitudinal direction of a surface of the element body, wherein
the protective layer comprises:
an inner layer formed on an end surface of the one end in the longitudinal direction of the base part, and on at least one principal surface of two principal surfaces of the element body in a region of a predetermined length in the longitudinal direction from the one end in the longitudinal direction; and
an outer layer covering a surface of the inner layer, and a surface of a region in which the inner layer is not formed on the at least part of the surface of the element body, and
wherein, on one principal surface in a region in which the inner layer is formed, a first space exists in at least a part between the inner layer and the outer layer, and
on said one principal surface in a region in which the inner layer is not formed on said one principal surface of the element body on which the first space exists, a second space exists in at least a part between said one principal surface and the outer layer.

(2) The sensor element according to the above (1), wherein an area ratio of an area of the first space to an area of the second space is 12 or less, in view of a plane configured with the principal surface of the element body.

(3) The sensor element according to the above (2), wherein the area ratio is more than 1.

(4) The sensor element according to the above (2) or (3), wherein the area ratio is 1.1 or more and 12 or less.

(5) The sensor element according to any one of the above (1) to (4), wherein, in a portion in which the protective layer exists on said one principal surface of the element body on which the first space and the second space exist, a ratio of a total area of the first space and the second space to an area of a part in which neither the first space nor the second space exists in the protective layer on said one principal surface is 2.3 or less, in view of a plane configured with the principal surface of the element body.

(6) The sensor element according to the above (5), wherein the ratio is 0.1 or more and 2.3 or less.

(7) The sensor element according to any one of the above (1) to (6), wherein a porosity of the outer layer in the protective layer is larger than a porosity of the inner layer in the protective layer.

(8) The sensor element according to any one of the above (1) to (7), wherein the element body comprises:
an inner electrode disposed on an inner surface of the measurement-object gas flow part; and
an outer electrode disposed corresponding to the inner electrode on one principal surface of the two principal surfaces of the element body, and
the inner layer, the first space and the second space exist on said one principal surface on which the outer electrode is disposed.
A gas sensor for detecting a target gas to be measured in a measurement-object gas, the gas sensor comprising a sensor element according to any one of the above (1) to (8) and a protection cover having an internal space for accommodating at least a portion in which the protective layer exists on the sensor element.

(9) A gas sensor for detecting a target gas to be measured in a measurement-object gas, the gas sensor comprising a sensor element according to any one of the above (1) to (8) and a protection cover having an internal space for accommodating at least a portion in which the protective layer exists on the sensor element, wherein
the protection cover has a vent hole though which a measurement-object gas flows above a portion in which the protective layer exists on at least one principal surface of the two principal surfaces of the element body.

(10) The gas sensor according to the above (9), wherein the protection cover has the vent hole above a portion in which the protective layer exists on said one principal surface of the element body on which the first space and the second space exist.

(11) The gas sensor according to the above (9) or (10), wherein the protection cover has the vent hole above a portion in which the first space exists on said one principal surface of the element body on which the first space and the second space exist.

### Advantageous Effect of the Invention

According to the present invention, it is possible to provide a sensor element and a gas sensor having higher water resistance.

### BRIEF DESCRIPTION OF THE DRAWINGS

FIG. 1 is a perspective view, showing one example of a general configuration of a sensor element 101.

FIG. 2 is a vertical sectional schematic view in the longitudinal direction, showing one example of a general configuration of a gas sensor 100 including the sensor element 101. FIG. 2 includes a sectional schematic view of the sensor element 101 along a line II-II in FIG. 1.

FIG. 3 is a schematic view of the same section as shown in FIG. 2, which shows the structure of a porous protective layer 90. In FIG. 3, the components inside an element body 102, such as the measurement-object gas flow part 15 and the electrodes, are not shown.

FIG. 4 is a schematic sectional view taken along a line IV-IV shown in FIG. 3. FIG. 4 shows a horizontal section of the porous protective layer 90 on a top surface of the element body 102. In FIG. 4, a broken line indicates a region in which an inner layer 91 exists and a dashed-dotted line indicates a region in which the element body 102 exists.

FIG. 5 is a schematic sectional view taken along a line V-V shown in FIG. 3. FIG. 5 is a schematic sectional view in a width direction perpendicular to the longitudinal direction of the element body 102. In FIG. 5, as in the case of FIG. 3, the components inside the element body 102, such as the measurement-object gas flow part 15 and the electrodes, are not shown.

FIG. 6 is a schematic sectional view showing the layout of the sensor element 101 and the protection cover 105. In FIG. 6, as in the case of FIG. 3, the components inside the element body 102, such as the measurement-object gas flow part 15 and the electrodes, are not shown.

### MODES FOR CARRYING OUT OF THE INVENTION

A sensor element of the present invention includes:
an element body that includes a base part in an elongated plate shape, including an oxygen-ion-conductive solid electrolyte layer, and a measurement-object gas flow part formed on a side of one end in a longitudinal direction of the base part; and
a porous protective layer that is formed from the one end in the longitudinal direction of the base part and covers at least a part in the longitudinal direction of a surface of the element body.

The protective layer includes:
an inner layer formed on an end surface of the one end in the longitudinal direction of the base part, and on at least one principal surface of two principal surfaces of the element body in a region of a predetermined length in the longitudinal direction from the one end in the longitudinal direction; and
an outer layer covering a surface of the inner layer, and a surface of a region in which the inner layer is not formed on the at least part of the surface of the element body, and
wherein, on one principal surface in a region in which the inner layer is formed, a first space exists in at least a part between the inner layer and the outer layer, and
on said one principal surface in a region in which the inner layer is not formed on said one principal surface of the element body on which the first space exists, a second space exists in at least a part between said one principal surface and the outer layer.

Hereinafter, an example of an embodiment of a gas sensor having the sensor element of the present invention will be described in detail.

[General Configuration of Gas Sensor]

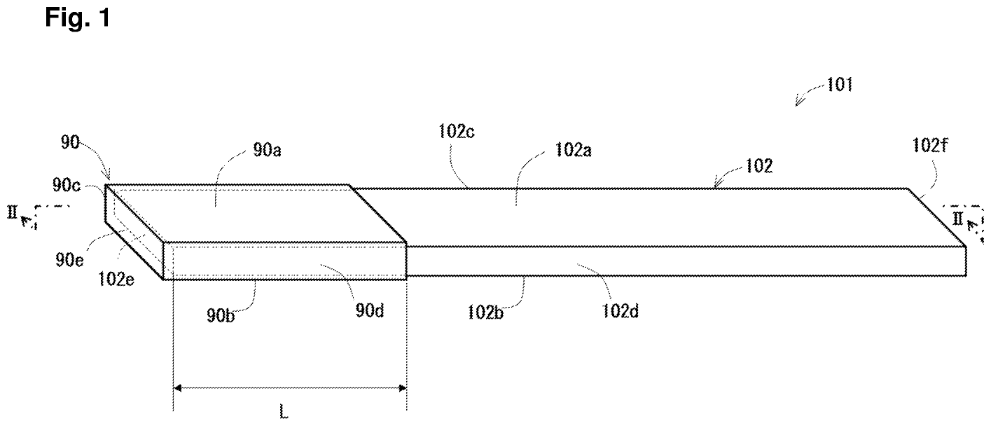

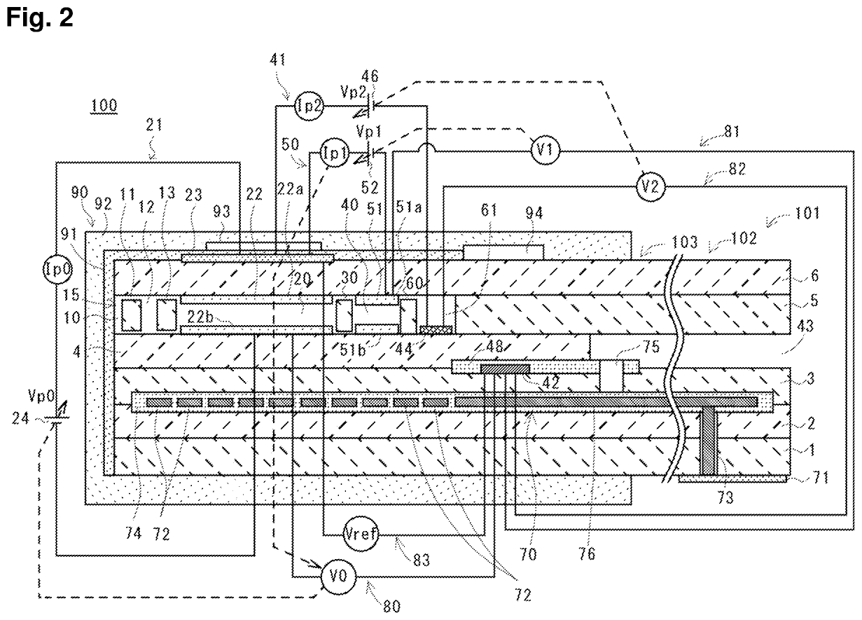

The gas sensor of the present invention will now be described with reference to the drawings. FIG. 1 is a perspective view, showing one example of a general configuration of a sensor element 101 included in a gas sensor 100. FIG. 2 is a vertical sectional schematic view in the longitudinal direction, showing one example of a general configuration of the gas sensor 100 including the sensor element 101. In FIG. 2, the sectional schematic view of the sensor element 101 is a sectional schematic view along a line II-II in FIG. 1. Hereinafter, based on FIG. 2, the upper side and the lower side in FIG. 2 are respectively defined as top and bottom, and the left side and the right side in FIG. 2 are respectively defined as a front end side and a rear end side. And, based on FIG. 2, the front side and the back side perpendicular to the paper are respectively defined as a right side and a left side.

In FIG. 2, the gas sensor 100 represents one example of a limiting current type NOx sensor that detects NOx in a measurement-object gas by the sensor element 101, and measures the concentration of NOx.

The sensor element 101 includes a porous protective layer 90 that will be described later in detail. The porous protective layer 90 corresponds to a protective layer of the present invention. A part of the sensor element 101 excluding the porous protective layer 90 is hereinafter referred to as an element body 102. The element body 102 has an elongated plate shape. As shown in FIG. 1, the element body 102 has six surfaces including two principal surfaces (a top surface 102a and a bottom surface 102b), two side surfaces along the longitudinal direction (a left surface 102c and a right surface 102d), and two end surfaces in the longitudinal direction (a front end surface 102e and a rear end surface 1020.

In the sensor element 101 of this embodiment, an inner main pump electrode 22, an auxiliary pump electrode 51, and a measurement electrode 44 are provided as inner electrodes. As an outer electrode, an outer pump electrode 23 is provided.

The sensor element 101 is an element in an elongated plate shape, including a base part 103 having such a structure that a plurality of oxygen-ion-conductive solid electrolyte layers are layered. The elongated plate shape also called a long plate shape or a belt shape. The base part 103 has such a structure that six layers, namely, a first substrate layer 1, a second substrate layer 2, a third substrate layer 3, a first solid electrolyte layer 4, a spacer layer 5, and a second solid electrolyte layer 6, are layered in this order from the bottom side, as viewed in the drawing. Each of the six layers is formed of an oxygen-ion-conductive solid electrolyte layer containing, for example, zirconia (ZrO₂). The solid electrolyte forming these six layers is dense and gastight. These six layers all may have the same thickness, or the thickness may vary among the layers. The layers are adhered to each other with an adhesive layer of a solid electrolyte interposed therebetween, and the base part 103 includes the adhesive layer. While a layer configuration composed of the six layers is illustrated in FIG. 2, the layer configuration in the present invention is not limited to this, and any number of layers and any layer configuration are possible.

The sensor element 101 is manufactured, for example, by stacking ceramic green sheets corresponding to the individual layers after conducting predetermined processing, printing of circuit pattern and the like, and then firing the stacked ceramic green sheets so that they are combined together.

A gas inlet 10 is formed between the lower surface of the second solid electrolyte layer 6 and the upper surface of the first solid electrolyte layer 4 in one end part in the longitudinal direction (hereinafter, referred to as a front end part) of the sensor element 101. A measurement-object gas flow part 15 is formed in such a form that a first diffusion-rate limiting part 11, a buffer space 12, a second diffusion-rate limiting part 13, a first internal cavity 20, a third diffusion-rate limiting part 30, a second internal cavity 40, a fourth diffusion-rate limiting part 60, and a third internal cavity 61 communicate in this order in the longitudinal direction from the gas inlet 10.

The gas inlet 10, the buffer space 12, the first internal cavity 20, the second internal cavity 40, and the third internal cavity 61 constitute internal spaces of the sensor element 101. Each of the internal spaces is provided in such a manner that a portion of the spacer layer 5 is hollowed out, and the top of each of the internal spaces is defined by the lower surface of the second solid electrolyte layer 6, the bottom of each of the internal spaces is defined by the upper surface of the first solid electrolyte layer 4, and the lateral surface of each of the internal spaces is defined by the lateral surface of the spacer layer 5.

Each of the first diffusion-rate limiting part 11, the second diffusion-rate limiting part 13, and the third diffusion-rate limiting part 30 is provided as two laterally elongated slits (having the longitudinal direction of the openings in the direction perpendicular to the figure in FIG. 2). Each of the first diffusion-rate limiting part 11, the second diffusion-rate limiting part 13, and the third diffusion-rate limiting part 30 may be in such a form that a desired diffusion resistance is created, but the form is not limited to the slits.

The fourth diffusion-rate limiting part 60 is provided as a single laterally elongated slit (having the longitudinal direction of the opening in the direction perpendicular to the figure in FIG. 2) between the spacer layer 5 and the second solid electrolyte layer 6. The fourth diffusion-rate limiting part 60 may be in such a form that a desired diffusion resistance is created, but the form is not limited to the slit.

Also, at a position farther from the front end than the measurement-object gas flow part 15, a reference gas introduction space 43 is disposed between the upper surface of the third substrate layer 3 and the lower surface of the spacer layer 5 at a position where the reference gas introduction space 43 is laterally defined by the lateral surface of the first solid electrolyte layer 4. The reference gas introduction space 43 has an opening in the other end part (hereinafter, referred to as a rear end part) of the sensor element 101. As a reference gas for NOx concentration measurement, for example, air is introduced into the reference gas introduction space 43.

An air introduction layer 48 is a layer formed of porous alumina, and is so configured that a reference gas is introduced into the air introduction layer 48 via the reference gas introduction space 43. The air introduction layer 48 is formed to cover a reference electrode 42.

The reference electrode 42 is an electrode sandwiched between the upper surface of the third substrate layer 3 and the first solid electrolyte layer 4, and as described above, the air introduction layer 48 leading to the reference gas introduction space 43 is disposed around the reference electrode 42. That is, the reference electrode 42 is disposed to be in contact with a reference gas via the air introduction layer 48 which is a porous material, and the reference gas introduction space 43. As will be described later, the reference electrode 42 can be used to measure the oxygen concentration (oxygen partial pressure) in the first internal cavity 20, the second internal cavity 40, and the third internal cavity 61. The reference electrode 42 is formed as a porous cermet electrode (e.g., a cermet electrode of Pt and ZrO₂).

In the measurement-object gas flow part 15, the gas inlet 10 is open to the external space, and the measurement-object gas is taken into the sensor element 101 from the external space through the gas inlet 10.

In the present embodiment, the measurement-object gas flow part 15 is in such a form that the measurement-object gas is introduced through the gas inlet 10 that is open on the front end surface of the sensor element 101, however, the present invention is not limited to this form. For example, the measurement-object gas flow part 15 need not have a recess of the gas inlet 10. In this case, the first diffusion-rate limiting part 11 substantially serves as a gas inlet.

For example, the measurement-object gas flow part 15 may have an opening that communicates with the buffer space 12 or a position near the buffer space 12 of the first internal cavity 20, on a lateral surface along the longitudinal direction of the base part 103. In this case, the measurement-object gas is introduced from the lateral surface along the longitudinal direction of the base part 103 through the opening.

Further, for example, the measurement-object gas flow part 15 may be so configured that the measurement-object gas is introduced through a porous body.

The first diffusion-rate limiting part 11 creates a predetermined diffusion resistance to the measurement-object gas taken through the gas inlet 10.

The buffer space 12 is provided to guide the measurement-object gas introduced from the first diffusion-rate limiting part 11 to the second diffusion-rate limiting part 13.

The second diffusion-rate limiting part 13 creates a predetermined diffusion resistance to the measurement-object gas introduced into the first internal cavity 20 from the buffer space 12.

It suffices that the amount of the measurement-object gas to be introduced into the first internal cavity 20 finally falls within a predetermined range. That is, it suffices that a predetermined diffusion resistance is created in a whole from the front end part of the sensor element 101 to the second diffusion-rate limiting part 13. For example, the first diffusion-rate limiting part 11 may directly communicate with the first internal cavity 20, or the buffer space 12 and the second diffusion-rate limiting part 13 may be absent.

The buffer space 12 is provided to mitigate the influence of pressure fluctuation on the detected value when the pressure of the measurement-object gas fluctuates.

When the measurement-object gas is introduced from outside the sensor element 101 into the first internal cavity 20, the measurement-object gas, which is rapidly taken through the gas inlet 10 into the sensor element 101 due to pressure fluctuation of the measurement-object gas in the external space (pulsations in exhaust pressure if the measurement-object gas is automotive exhaust gas), is not directly introduced into the first internal cavity 20. Rather, the measurement-object gas is introduced into the first internal cavity 20 after the pressure fluctuation of the measurement-object gas is eliminated through the first diffusion-rate limiting part 11, the buffer space 12, and the second diffusion-rate limiting part 13. Thus, the pressure fluctuation of the measurement-object gas introduced into the first internal cavity 20 becomes almost negligible.

The first internal cavity 20 is provided as a space for adjusting the oxygen partial pressure in the measurement-object gas introduced through the second diffusion-rate limiting part 13. The oxygen partial pressure is adjusted by operation of a main pump cell 21.

The main pump cell 21 is an electrochemical pump cell including the inner main pump electrode 22 as an inner electrode disposed on the inner surface of the measurement-object gas flow part 15, and the outer pump electrode 23 as an outer electrode corresponding to the inner main pump electrode 22 and disposed on one principal surface of the two principal surfaces of the element body 102 to be in contact with the inner main pump electrode 22 via a solid electrolyte (in FIG. 2, via the second solid electrolyte layer 6).

That is, the main pump cell 21 is an electrochemical pump cell composed of the inner main pump electrode 22 having a ceiling electrode portion 22a disposed over substantially the entire surface of the lower surface of the second solid electrolyte layer 6 that faces the first internal cavity 20, the outer pump electrode 23 disposed on a region of the upper surface of the second solid electrolyte layer 6 that corresponds to the ceiling electrode portion 22a so as to be exposed to the external space, and the second solid electrolyte layer 6 sandwiched between the inner main pump electrode 22 and the outer pump electrode 23.

The inner main pump electrode 22 is disposed facing the first internal cavity 20. That is, the inner main pump electrode 22 is formed to span the upper and lower solid electrolyte layers (the second solid electrolyte layer 6 and the first solid electrolyte layer 4) that define the first internal cavity 20 and the spacer layer 5 that defines the lateral wall. Specifically, the ceiling electrode portion 22a is formed on the lower surface of the second solid electrolyte layer 6 that defines the ceiling surface of the first internal cavity 20, and a bottom electrode portion 22b is formed on the upper surface of the first solid electrolyte layer 4 that defines the bottom surface of the first internal cavity 20. Also, lateral electrode portions (not shown) are formed on the lateral wall surfaces (inner surface) of the spacer layer 5 that form both lateral wall parts of the first internal cavity 20 so as to connect the ceiling electrode portion 22a and the bottom electrode portion 22b. Thus, the inner main pump electrode 22 is provided as a tunnel-like structure in the area where the lateral electrode portions are disposed.

The inner main pump electrode 22 and the outer pump electrode 23 are each formed as a porous cermet electrode (e.g., a cermet electrode of Pt containing 1% Au and ZrO₂). It is to be noted that the inner main pump electrode 22 to be in contact with the measurement-object gas is formed using a material having a weakened ability to reduce a NOx component in the measurement-object gas.

In the main pump cell 21, a desired pump voltage Vp0 is applied between the inner main pump electrode 22 and the outer pump electrode 23 by a variable power supply 24 to flow a pump current Ip0 between the inner main pump electrode 22 and the outer pump electrode 23 in either a positive or negative direction, and thus it is possible to pump out oxygen in the first internal cavity 20 to the external space or pump oxygen into the first internal cavity 20 from the external space.

To detect the oxygen concentration (oxygen partial pressure) in the atmosphere in the first internal cavity 20, the inner main pump electrode 22, the second solid electrolyte layer 6, the spacer layer 5, the first solid electrolyte layer 4, the third substrate layer 3, and the reference electrode 42 form an electrochemical sensor cell, namely, an oxygen-partial-pressure detection sensor cell 80 for main pump control.

The oxygen concentration (oxygen partial pressure) in the first internal cavity 20 can be detected from an electromotive force V0 measured in the oxygen-partial-pressure detection sensor cell 80 for main pump control. In addition, the pump current Ip0 is controlled by performing feedback control of the pump voltage Vp0 in the variable power supply 24 so that the electromotive force V0 is constant. Thus, the oxygen concentration in the first internal cavity 20 can be maintained at a predetermined constant value.

The third diffusion-rate limiting part 30 creates a predetermined diffusion resistance to the measurement-object gas whose oxygen concentration (oxygen partial pressure) has been controlled in the first internal cavity 20 by the operation of the main pump cell 21, and guides the measurement-object gas into the second internal cavity 40.

The second internal cavity 40 is provided as a space for adjusting the oxygen partial pressure in the measurement-object gas introduced through the third diffusion-rate limiting part 30 more accurately. The oxygen partial pressure is adjusted by operation of an auxiliary pump cell 50. The sensor element 101 may be configured without the second internal cavity 40 and the auxiliary pump cell 50. From the viewpoint of adjusting accuracy of oxygen partial pressure, it is more preferred that the second internal cavity 40 and the auxiliary pump cell 50 be provided.

After the oxygen concentration (oxygen partial pressure) in the measurement-object gas is adjusted in advance in the first internal cavity 20, the measurement-object gas is introduced through the third diffusion-rate limiting part 30, and is further subjected to adjustment of the oxygen partial pressure by the auxiliary pump cell 50 in the second internal cavity 40. Thus, the oxygen concentration in the second internal cavity 40 can be kept constant with high accuracy, and the NOx concentration can be measured with high accuracy in the gas sensor 100.

The auxiliary pump cell 50 is an electrochemical pump cell including the auxiliary pump electrode 51 as an inner electrode disposed at a position farther from the front end portion of the base part 103 than the inner main pump electrode 22 on the inner surface of the measurement-object gas flow part 15, and the outer pump electrode 23 as an outer electrode corresponding to the auxiliary pump electrode 51 and disposed to be in contact with the auxiliary pump electrode 51 via a solid electrolyte (in FIG. 2, via the second solid electrolyte layer 6).

That is, the auxiliary pump cell 50 is an auxiliary electrochemical pump cell composed of the auxiliary pump electrode 51 having a ceiling electrode portion 51a disposed on substantially the entire surface of the lower surface of the second solid electrolyte layer 6 facing with the second internal cavity 40, the outer pump electrode 23 (the outer electrode is not limited to the outer pump electrode 23, but may be any suitable electrode outside the sensor element 101), and the second solid electrolyte layer 6.

This auxiliary pump electrode 51 is disposed in the second internal cavity 40 in a tunnel-like structure similar to the inner main pump electrode 22 disposed in the first internal cavity 20 described previously. Specifically, in the tunnel-like structure, the ceiling electrode portion 51a is formed on the lower surface of the second solid electrolyte layer 6 that defines the ceiling surface of the second internal cavity 40, a bottom electrode portion 51b is formed on the upper surface of the first solid electrolyte layer 4 that defines the bottom surface of the second internal cavity 40, and lateral electrode portions (not shown) connecting the ceiling electrode portion 51a and the bottom electrode portion 51b are formed on the wall surfaces of the spacer layer 5 that define the lateral walls of the second internal cavity 40.

It is to be noted that the auxiliary pump electrode 51 is formed using a material having a weakened ability to reduce a NOx component in the measurement-object gas, as with the case of the inner main pump electrode 22.

In the auxiliary pump cell 50, by applying a desired voltage Vp1 between the auxiliary pump electrode 51 and the outer pump electrode 23, it is possible to pump out oxygen in the atmosphere in the second internal cavity 40 to the external space, or pump the oxygen into the second internal cavity 40 from the external space.

To control the oxygen partial pressure in the atmosphere in the second internal cavity 40, the auxiliary pump electrode 51, the reference electrode 42, the second solid electrolyte layer 6, the spacer layer 5, the first solid electrolyte layer 4, and the third substrate layer 3 constitute an electrochemical sensor cell, namely, an oxygen-partial-pressure detection sensor cell 81 for auxiliary pump control.

The auxiliary pump cell 50 performs pumping with a variable power supply 52 whose voltage is controlled on the basis of an electromotive force V1 detected by the oxygen-partial-pressure detection sensor cell 81 for auxiliary pump control. Thus, the oxygen partial pressure in the atmosphere in the second internal cavity 40 is controlled to such a low partial pressure that does not substantially affect measurement of NOx.

In addition, a pump current Ip1 is used for control of the electromotive force of the oxygen-partial-pressure detection sensor cell 80 for main pump control. Specifically, the pump current Ip1 is input to the oxygen-partial-pressure detection sensor cell 80 for main pump control as a control signal to control the electromotive force V0, and thus the gradient of the oxygen partial pressure in the measurement-object gas introduced into the second internal cavity 40 from the third diffusion-rate limiting part 30 is controlled to remain constant. In using as a NOx sensor, the oxygen concentration in the second internal cavity 40 is kept at a constant value of about 0.001 ppm by the actions of the main pump cell 21 and the auxiliary pump cell 50.

The fourth diffusion-rate limiting part 60 creates a predetermined diffusion resistance to the measurement-object gas whose oxygen concentration (oxygen partial pressure) has been controlled to further low in the second internal cavity 40 by the operation of the auxiliary pump cell 50, and guides the measurement-object gas into the third internal cavity 61.

The third internal cavity 61 is provided as a space for measuring nitrogen oxide (NOx) concentration in the measurement-object gas introduced through the fourth diffusion-rate limiting part 60. By the operation of a measurement pump cell 41, NOx concentration is measured.

The measurement pump cell 41 measures NOx concentration in the measurement-object gas in the third internal cavity 61. The measurement pump cell 41 is an electrochemical pump cell including a measurement electrode 44 as an inner electrode disposed at a position farther from the front end portion of the base part 103 than the auxiliary pump electrode 51 on the inner surface of the measurement-object gas flow part 15, and the outer pump electrode 23 as an outer electrode corresponding to the measurement electrode 44 and disposed to be in contact with the measurement electrode 44 via a solid electrolyte (in FIG. 2, via the second solid electrolyte layer 6, the spacer layer 5, and the first solid electrolyte layer 4).

That is, the measurement pump cell 41 is an electrochemical pump cell composed of the measurement electrode 44 disposed on the upper surface of the first solid electrolyte layer 4 facing with the third internal cavity 61, the outer pump electrode 23 (the outer electrode is not limited to the outer pump electrode 23, but may be any suitable electrode outside the sensor element 101), the second solid electrolyte layer 6, the spacer layer 5, and the first solid electrolyte layer 4.

The measurement electrode 44 is a porous cermet electrode. The measurement electrode 44 functions also as a NOx reduction catalyst that reduces NOx present in the atmosphere in the third internal cavity 61.

In the measurement pump cell 41, oxygen generated by decomposition of nitrogen oxide in the atmosphere around the measurement electrode 44 is pumped out, and the amount of generated oxygen can be detected as a pump current Ip2.

To detect the oxygen partial pressure around the measurement electrode 44, the first solid electrolyte layer 4, the third substrate layer 3, the measurement electrode 44, and the reference electrode 42 constitute an electrochemical sensor cell, namely an oxygen-partial-pressure detection sensor cell 82 for measurement pump control. A variable power supply 46 is controlled on the basis of an electromotive force V2 detected by the oxygen-partial-pressure detection sensor cell 82 for measurement pump control.

The measurement-object gas introduced into the second internal cavity 40 reaches the measurement electrode 44 through the fourth diffusion-rate limiting part 60 under the condition that the oxygen partial pressure is controlled. Nitrogen oxide in the measurement-object gas around the measurement electrode 44 is reduced (2NO→N₂+O₂) to generate oxygen. The generated oxygen is to be pumped by the measurement pump cell 41, and at this time, a voltage Vp2 of the variable power supply 46 is controlled so that the electromotive force V2 detected by the oxygen-partial-pressure detection sensor cell 82 for measurement pump control is constant. Since the amount of oxygen generated around the measurement electrode 44 is proportional to the concentration of nitrogen oxide in the measurement-object gas, nitrogen oxide concentration in the measurement-object gas is calculated by using the pump current Ip2 in the measurement pump cell 41.

By configuring oxygen partial pressure detecting means by an electrochemical sensor cell composed of a combination of the measurement electrode 44, the first solid electrolyte layer 4, the third substrate layer 3 and the reference electrode 42, it is possible to detect an electromotive force in accordance with a difference between the amount of oxygen generated by reduction of NOx components in the atmosphere around the measurement electrode 44 and the amount of oxygen contained in the reference air, and hence it is possible to determine the concentration of NOx components in the measurement-object gas.

Also, the second solid electrolyte layer 6, the spacer layer 5, the first solid electrolyte layer 4, the third substrate layer 3, the outer pump electrode 23, and the reference electrode 42 constitute an electrochemical sensor cell 83, and it is possible to detect the oxygen partial pressure in the measurement-object gas outside the sensor by an electromotive force Vref obtained by the sensor cell 83.

In the gas sensor 100 having such a configuration, the main pump cell 21 and the auxiliary pump cell 50 are operated to supply a measurement-object gas whose oxygen partial pressure is usually kept at a low constant value (the value that does not substantially affect measurement of NOx) to the measurement pump cell 41. Therefore, NOx concentration in the measurement-object gas can be detected on the basis of the pump current Ip2 that flows as a result of pumping out of the oxygen generated by reduction of NOx by the measurement pump cell 41 and is almost in proportion to the concentration of NOx in the measurement-object gas.

The sensor element 101 further includes a heater part 70 that functions as a temperature regulator of heating and maintaining the temperature of the sensor element 101 so as to enhance the oxygen ion conductivity of the solid electrolyte. The heater part 70 includes a heater electrode 71, a heater 72, a heater lead 76, a through hole 73, a heater insulating layer 74, and a pressure relief vent 75.

The heater electrode 71 is an electrode formed in contact with the lower surface of the first substrate layer 1. The power can be supplied to the heater part 70 from the outside by connecting the heater electrode 71 with a heater power supply that is an external power supply.

The heater 72 is an electrical resistor sandwiched by the second substrate layer 2 and the third substrate layer 3 from top and bottom. The heater 72 is connected with the heater electrode 71 via a heater lead 76 that connects with the heater 72 and extends in the rear end side in the longitudinal direction of the sensor element 101, and the through hole 73. The heater 72 is externally powered through the heater electrode 71 to generate heat, and heats and maintains the temperature of the solid electrolyte forming the sensor element 101.

The heater 72 is embedded over the whole area from the first internal cavity 20 to the third internal cavity 61 so that the temperature of the entire sensor element 101 can be adjusted to such a temperature that activates the solid electrolyte. The temperature may be adjusted so that the main pump cell 21, the auxiliary pump cell 50, and the measurement pump cell 41 are operable. It is not necessary that the whole area is adjusted to the same temperature, but the sensor element 101 may have temperature distribution.

In the sensor element 101 of the present embodiment, the heater 72 is embedded in the base part 103, but this form is not limitative. The heater 72 may be disposed to heat the base part 103. That is, the heater 72 may heat the sensor element 101 to develop oxygen ion conductivity with which the main pump cell 21, the auxiliary pump cell 50, and the measurement pump cell 41 are operable. For example, the heater 72 may be embedded in the base part 103 as in the present embodiment. Alternatively, for example, the heater part 70 may be formed as a heater substrate that is separate from the base part 103, and may be disposed at a position adjacent to the base part 103.

The heater insulating layer 74 is formed of an insulator such as alumina on the upper and lower surfaces of the heater 72 and the heater lead 76. The heater insulating layer 74 is formed to ensure electrical insulation between the second substrate layer 2, and the heater 72 and the heater lead 76, and electrical insulation between the third substrate layer 3, and the heater 72 and the heater lead 76.

The pressure relief vent 75 extends through the third substrate layer 3 so that the heater insulating layer 74 and the reference gas introduction space 43 communicate with each other. The pressure relief vent 75 can mitigate an increase in internal pressure due to temperature rise in the heater insulating layer 74. The pressure relief vent 75 may be absent.

(Protective Layer)

The sensor element 101 includes the element body 102 and the porous protective layer 90 that is formed from the one end in the longitudinal direction of the element body 102 (the base part 103) and covers at least a part in the longitudinal direction of a surface of the element body 102. Here, the one end in the longitudinal direction of the element body 102 is the one end on a side of which the measurement-object gas flow part 15 is formed, namely, the front end of the element body 102. The element body 102 is in an elongated plate shape, and the top surface 102a and the bottom surface 102b of the element body 102 are principal surfaces. The left surface 102c and the right surface 102d are also referred to as the side surfaces, and the front end surface 102e and the end surface 102f are also referred to as the end surfaces.

In this embodiment, the porous protective layer 90 covers a predetermined area (an area indicated by a broken line in FIG. 1) of the element body 102 in the longitudinal direction from the front end of the element body 102. As shown in FIG. 1, the porous protective layer 90 includes porous protective layers 90a to 90e. The porous protective layer 90a entirely covers a part of the top surface 102a of the element body 102 which extends for a predetermined length L in the longitudinal direction from the front end of the element body 102. The porous protective layer 90b entirely covers a part of the bottom surface 102b of the element body 102 which extends for a predetermined length L in the longitudinal direction from the front end of the element body 102. The porous protective layer 90c entirely covers a part of the left surface 102c of the element body 102 which extends for a predetermined length L in the longitudinal direction from the front end of the element body 102. The porous protective layer 90d entirely covers a part of the right surface 102d of the element body 102 which extends for a distance A in the longitudinal direction from the front end of the element body 102. The porous protective layer 90e entirely covers the front end surface of the element body 102.

As shown in FIG. 2, the porous protective layer 90e also covers the gas inlet 10. However, a measurement-object gas can reach the gas inlet 10 through the inside of the porous protective layer 90e because the porous protective layer 90e is a porous material. Therefore, a target gas to be measured can be detected and measured without problem.

The porous protective layer 90 plays a role of suppressing the occurrence of cracking in the internal structure of the element body 102 when, for example, water is splashed on the sensor element 101 having a high temperature during operation of the gas sensor. Water that has reached the sensor element 101 is not directly attached to the surface of the element body 102 but is attached to the porous protective layer 90. The surface of the porous protective layer 90 is rapidly cooled by the attached water, but thermal shock applied to the element body 102 is reduced by the heat insulating effect of the porous protective layer 90. This, as a result, makes it possible to suppress the occurrence of cracking in the internal structure of the element body 102. That is, the water resistance of the sensor element 101 improves.

The porous protective layer 90a may cover the outer pump electrode 23. The porous protective layer 90a also plays a role of suppressing the attachment of an oil component or the like contained in a measurement-object gas to the outer pump electrode 23 to prevent degradation of the outer pump electrode 23.

The porous protective layer 90 comprises a porous material. Examples of a constituent material of the porous protective layer 90 include alumina, zirconia, spinel, cordierite, mullite, titania, and magnesia. Any one or two or more of them may be used. In this embodiment, the porous protective layer 90 comprises an alumina porous material.

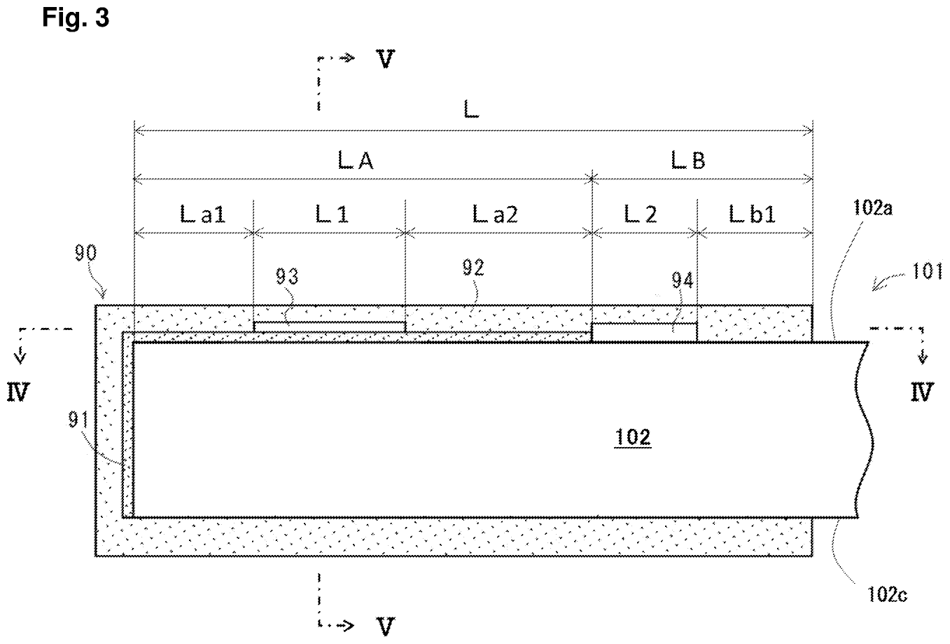

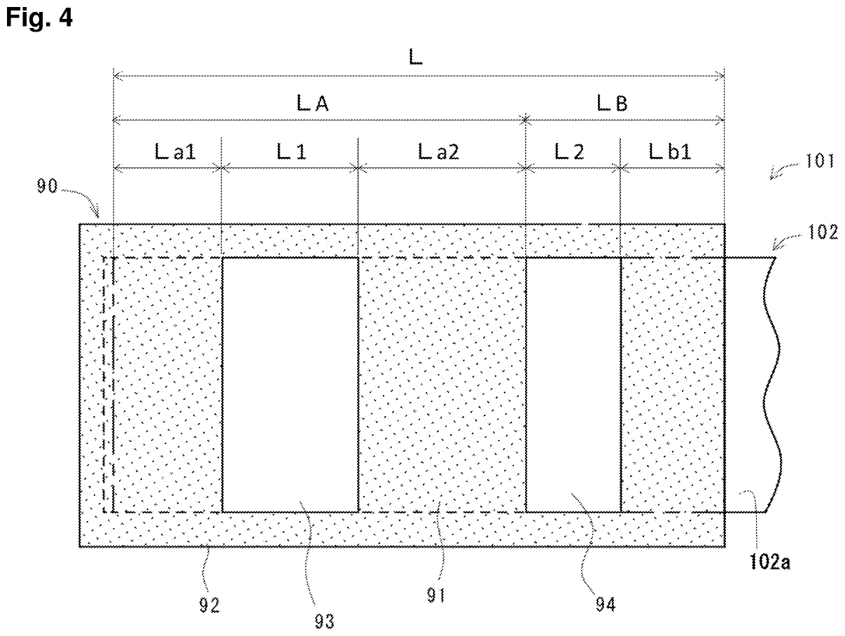

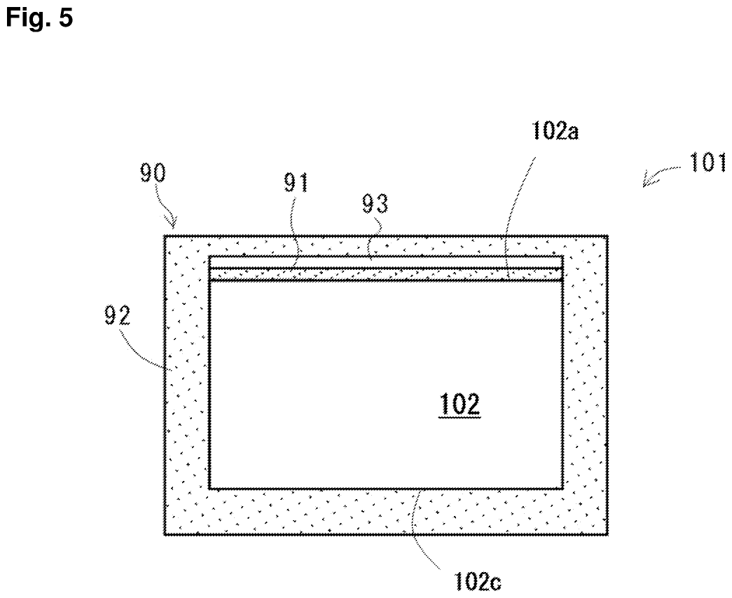

The porous protective layer 90 includes an inner layer 91 and an outer layer 92. FIG. 3 is a schematic view of the same section as shown in FIG. 2, which shows the structure of the porous protective layer 90. In FIG. 3, the components inside the element body 102, such as the measurement-object gas flow part 15 and the electrodes, are not shown. FIG. 4 is a schematic sectional view taken along a line IV-IV shown in FIG. 3. FIG. 4 shows a horizontal section of the porous protective layer 90 on the top surface of the element body 102. In FIG. 4, a broken line indicates a region in which the inner layer 91 exists and a dashed-dotted line indicates a region in which the element body 102 exists. FIG. 5 is a schematic sectional view taken along a line V-V shown in FIG. 3. FIG. 5 is a schematic sectional view in a width direction perpendicular to the longitudinal direction of the element body 102. In FIG. 5, as in the case of FIG. 3, the components inside the element body 102, such as the measurement-object gas flow part 15 and the electrodes, are not shown.

The inner layer 91 is formed on the end surface of the one end (front end) in the longitudinal direction of the base part 103 (element body 102), and on at least one principal surface of the two principal surfaces of the element body 102 in a region of a predetermined length in the longitudinal direction from the one end in the longitudinal direction. In this embodiment, the inner layer 91 is formed on the entire surface of the front end surface 102e of the element body 102, and on the entire surface of a region of a length LA in the longitudinal direction from the front end of the element body 102 on one principal surface (top surface 102a), on which the outer pump electrode 23 is formed, of the two principal surfaces of the element body 102. The length (LA) in the longitudinal direction of the inner layer 91 is shorter than the length L in the longitudinal direction of the porous protective layer 90 (LA<L). Hereinafter, the top surface 102a is also referred to as a pump surface 102a. One principal surface (bottom surface 102b) of the two principal surfaces of the element body 102 opposite to the pump surface 102a is also referred to as a heater surface 102b. The inner layer 91 may be formed on both of the two principal surfaces (the pump surface 102a and the heater surface 102b) or may be formed on one or both of the two side surfaces of the element body 102. In such a case, the lengths (LA) in the longitudinal direction of the inner layer 91 in the respective surfaces may be different from each other.

The outer layer 92 is formed to cover the surface of the inner layer 91 and the surface of a region in which the inner layer 91 is not formed on the at least part of the surface of the element body 102. That is, the outer layer 92 covers the surface of the inner layer 91 and the surface of a region, in which the inner layer 91 is not formed, in a portion covered with the porous protective layer 90 in the element body 102.

Therefore, in this embodiment, the porous protective layer 90a on the top surface 102a of the element body 102 is constituted from the inner layer 91 of the length LA in the longitudinal direction from the front end of the element body 102 and the outer layer 92 that entirely covers the inner layer in the longitudinal direction from the front end of the element body 102 and further extends to have the length L. That is, in the region of the length LA in the longitudinal direction from the front end of the element body 102, the porous protective layer 90a is constituted from two layers of the inner layer 91 and the outer layer 92, and in a region of a length LB in the longitudinal direction posterior to the rear end of the inner layer 91, the porous protective layer 90a is constituted from one layer of the outer layer 92. The porous protective layer 90b on the bottom surface 102b of the element body 102 is constituted from the outer layer 92 that extends in the longitudinal direction from the front end of the element body 102 to have the length L. The porous protective layer 90c on the left surface of the element body 102 is constituted from the outer layer 92 that extends in the longitudinal direction from the front end of the element body 102 to have the length L. The porous protective layer 90d on the right surface of the element body 102 is constituted from the outer layer 92 that extends in the longitudinal direction from the front end of the element body 102 to have the length L. That is, the porous protective layers 90b to 90d are constituted from one layer of the outer layer 92. The porous protective layer 90e on the front end surface of the element body 102 is constituted from the inner layer 91 that entirely covers the front end surface and the outer layer 92 that entirely covers the inner layer 91. That is, the porous protective layer 90e is constituted from two layers of the inner layer 91 and the outer layer 92.

The element body 102 shown in FIGS. 2 to 5 has a rectangular section, but the sectional shape of the element body 102 is not limited to a substantially rectangular shape. In view of any one of the sections, for example, the element body 102 may have roughly right-angled corners or beveled or curved corners. When the element body 102 has beveled or curved corners, the porous protective layer 90 may cover beveled or curved portions of the corners in the region of the length L in the longitudinal direction from the front end of the element body 102. That is, the porous protective layer 90 may cover substantially the entire outer surface of the length L in the longitudinal direction from the front end of the element body 102. Further, in the width-direction section shown in FIG. 5, for example, when the element body 102 has beveled corners, the inner layer 91 may be formed on the pump surface 102a and beveled portions on the both sides thereof.

Each of the porous protective layer 90, the inner layer 91, and the outer layer 92 shown in FIGS. 2 to 5 has a rectangular section, but the sectional shape thereof is not limited to a rectangle. In view of any one of the sections, the corners of the surface of the porous protective layer 90, that is, the corners of the surface of the outer layer 92 may not have a right angle and may be rounded. As for the shape of the inner layer 91, the corners may not have a right angle and may be rounded in view of any one of the sections. For example, in the sections shown in FIG. 2 and FIG. 3, the porous protective layer 90 may have, near the rear end thereof, a shape such that the thickness is gradually reduced toward the rear end. The shape of the inner layer 91 is also the same as those of the porous protective layer 90 and the outer layer 92. The porous protective layer 90 has a roughly uniform thickness except for the corners and the ends.

The porous protective layer 90 in this embodiment entirely covers a part of the element body 102 (90a, 90b, 90c, 90d, 90e) which includes its front end surface and extends for the length L in the longitudinal direction of the element body 102 from the front end surface. The length L should be determined to fall within a range of 0<length L<entire longitudinal length of element body 102 on the basis of the area of the element body 102 to be exposed to a measurement-object gas in the gas sensor 100, the position of the outer pump electrode 23, the position of the measurement-object gas flow part 15, or the like.

The porous protective layer 90 (outer layer 92) may cover a portion having a high temperature during the driving of the gas sensor in the element body 102. Alternatively, the porous protective layer 90 may almost entirely cover a portion exposed to the measurement-object gas in the element body 102. For example, the porous protective layer 90 may be formed to cover almost the entirety from the front end of the element body 102 to a position in the longitudinal direction in which the reference electrode 42 is formed. Alternatively, for example, the porous protective layer 90 may be formed to cover almost the entirety from the front end of the element body 102 to the position of a front end-side side surface of the reference gas introduction space 43 in the longitudinal direction. Alternatively, the porous protective layer 90 may cover almost from the front end of the element body 102 to a position farther from the position of the front end-side side surface of the reference gas introduction space 43 in the longitudinal direction. The porous protective layers 90a to 90d may be different from each other in the length in the longitudinal direction of the element body 102.

The length LA of the inner layer 91 of the porous protective layer 90 is shorter than the length L of the entire porous protective layer 90. The length LA of the inner layer 91 may be determined on the basis of the area of the element body 102 to be exposed to a measurement-object gas in the gas sensor 100, the position of the outer pump electrode 23, the position of the measurement-object gas flow part 15, or the like.

For example, the length LA of the inner layer 91 in the longitudinal direction from the front end of the element body 102 may be a length such that the outer pump electrode 23 is entirely covered or a length as long as the length of the measurement-object gas flow part 15 in the longitudinal direction of the element body 102. Alternatively, the length LA may be determined based on, for example, the temperature of the sensor element 101 during the driving of the gas sensor 100. The length LA may be determined so that the inner layer 91 is formed in a portion of the sensor element 101 having a high temperature (e.g., 500° C. or higher) during the driving of the gas sensor 100. The length LA of the inner layer 91 may be determined previously, and then the length L of the entire porous protective layer 90 may be determined based on the length LA of the inner layer 91 previously determined.

The length LA of the inner layer 91 in the longitudinal direction from the front end of the element body 102 may vary depending on the structure of the element body 102, and may be, for example, 2 mm or more, or 5 mm or more. The length LA may be, for example, 12 mm or less, or 9 mm or less.

The length L of the entire porous protective layer 90 in the longitudinal direction from the front end of the element body 102 may vary depending on the structure of the element body 102, and may be, for example, 7 mm or more, or 10 mm or more. The length L may be, for example, 17 mm or less, or 14 mm or less.

A thickness of the porous protective layer 90 may be, for example, 100 μm or more and 1000 μm or less. Alternatively, the thickness of the porous protective layer 90 may be, for example, 100 μm or more and 500 μm or less. A thickness of the inner layer 91 may be, for example, 50 μm or more and 500 μm or less. Alternatively, the thickness of the inner layer 91 may be, for example, 50 μm or more and 200 μm or less. A thickness of the outer layer 92 in a portion covering the inner layer 91 may be 50 μm or more and 950 μm or less. Alternatively, the thickness of the outer layer 92 in a portion covering the inner layer 91 may be, for example, 50 μm or more and 450 μm or less. A thickness of the outer layer 92 in a portion where the inner layer 91 does not exist may be, for example, 100 μm or more and 1000 μm or less. Alternatively, the thickness of the outer layer 92 in a portion where the inner layer 91 does not exist may be, for example, 100 μm or more and 500 μm or less. In this embodiment, all the porous protective layers 90a to 90e on respective surfaces of the element body 102 have the same thickness. However, the porous protective layers 90a to 90e may be different from each other in thickness.

The thickness is determined in the following manner using an image (SEM image) obtained by observation with a scanning electron microscope (SEM). In an area where the porous protective layer 90 is present, the sensor element 101 is cut orthogonally to the longitudinal direction of the sensor element 101. The cut surface is embedded in a resin and polished to prepare an observation sample. The magnification of the SEM is set to 80 times, and the surface to be observed of the observation sample is imaged to obtain an SEM image of section of the porous protective layer 90. A direction perpendicular to the surface of the element body 102 is defined as a thickness direction, a distance between the surface of the porous protective layer 90 and the interface with the element body 102 is determined, and the distance is defined as the thickness of the porous protective layer 90. The thickness of each of the inner layer 91 and the outer layer 92 is also determined in the same manner. It is to be noted that, in the outer layer 92 in the portion covering the inner layer 91, a distance between the surface of the outer layer 92 and the interface with the inner layer 91 is defined as the thickness of the outer layer 92.

A porosity of the porous protective layer 90 (each of a porosity of the inner layer 91 and a porosity of the outer layer 92) may be, for example, 10% by volume to 80% by volume. Alternatively, the porosity may be, for example, 10% by volume to 70% by volume, or, 10% by volume to 40% by volume.

The inner layer 91 and the outer layer 92 may have the same porosity, or may be different from each other in porosity. It is more preferred that the porosity of the outer layer 92 is higher than that of the inner layer 91 of the porous protective layer 90.

The porosity is determined in the following manner using an image (SEM image) obtained by observation with a scanning electron microscope (SEM). As in the case of determination of the thickness described above, the magnification of the SEM is set to 80 times, and the SEM image of section of the inner layer 91 of the porous protective layer 90 is obtained. Then, the obtained SEM image is binarized using “Otsu's method” (also referred to as discriminant analysis method). In the binarized image, alumina is shown in white and pores are shown in black. In the binarized image, area of alumina portions (white) and area of pore portions (black) are obtained. The ratio of the area of the pore portions to total area (total of the area of the alumina portions and the area of the pore portions) is calculated and defined as porosity of the inner layer 91. The porosity of the outer layer 92 is also determined in the same manner. It is to be noted that the inner layer 91 is considered to have substantially the same microstructure regardless of observation area. Therefore, as described above, the porosity determined using one sectional image may be used as the porosity of the inner layer 91. The same is true for the outer layer 92.

In the sensor element 101 of the present invention,
on the one principal surface in a region in which the inner layer 91 is formed, a first space 93 exists in at least a part between the inner layer 91 and the outer layer 92, and
on said one principal surface in a region in which the inner layer 91 is not formed on said one principal surface of the element body 102 on which the first space 93 exists, a second space 94 exists in at least a part between said one principal surface and the outer layer 92.

The first space 93 exists in at least a part between the inner layer 91 and the outer layer 92 on the one principal surface (in this embodiment, the pump surface 102a) in a region in which the inner layer 91 is formed. The first space 93 is a layer-shaped space having a predetermined length (L1) in the longitudinal direction of the element body 102. That is, the first space 93 is interposed between the inner layer 91 and the outer layer 92 in at least a part of a region in which the inner layer 91 is formed on the pump surface. In a region in which the first space 93 is not interposed between the inner layer 91 and the outer layer 92, the inner layer 91 and the outer layer 92 are in close contact with each other. In FIG. 3 and FIG. 4, a region of a length La1 from the front end of the element body 102 to the front end of the first space 93 and a region of a length La2 from the rear end of the first space 93 to the rear end of the inner layer 91 are close-contact regions (adhesion regions) in which the inner layer 91 and the outer layer 92 are in close contact with (adhere to) each other.

The second space 94 exists in at least a part between the element body 102 and the outer layer 92 on the one principal surface (in this embodiment, the pump surface 102a) in a region in which the inner layer 91 in the porous protective layer 90 is not formed on the one principal surface of the element body 102 on which the first space 93 exists. The second space 94 is a layer-shaped space having a predetermined length (L2) in the longitudinal direction of the element body 102. That is, the second space 94 is interposed between the element body 102 and the outer layer 92 in at least a part of a region in which the inner layer 91 is not formed and only the outer layer 92 is formed on the pump surface 102a. In a region in which the second space 94 is not interposed between the element body 102 and the outer layer 92, the element body 102 and the outer layer 92 are in close contact with each other. In FIG. 3 and FIG. 4, a region of a length Lb1 from the rear end of the second space 94 to the rear end of the outer layer 92 is a close-contact region (adhesion region) in which the element body 102 and the outer layer 92 are in close contact with (adhere to) each other.

The second space 94 exists in a position farther from the front end of the element body 102 than the first space 93. In this embodiment, the second space 94 exists from the rear end of the inner layer 91 as shown in FIG. 3, but is not limited thereto. In the longitudinal direction of the element body 102, the close-contact region in which the element body 102 and the outer layer 92 are in close contact with each other may exist between the rear end of the inner layer 91 and the front end of the second space 94.

Both the first space 93 and the second space 94 function as a thermal insulating space between the inner layer 91 or the element body 102 and the outer layer 92. A space has a thermal capacity larger than that of a porous body. Therefore, even when water attaches to the surface of the outer layer 92 so that the surface of the outer layer 92 is rapidly cooled, thermal shock to the element body 102 is reduced due to the interposition of the first space 93 and the second space 94. This makes it possible to suppress cracking in the internal structure of the element body 102 caused by thermal shock

The first space 93 and the second space 94 exist as different spaces. That is, in the longitudinal direction of the element body 102, the close-contact region exists between the first space 93 and the second space 94. In FIG. 3 and FIG. 4, the region of the length La2 corresponds to the close-contact region. It is considered that adhesive strength between the inner layer 91 and the outer layer 92 is maintained by the close-contact region, which makes it possible to more effectively prevent the outer layer 92 from being peeled off from the element body 102.

The first space 93 may preferably exist in at least a part of the position of the measurement-object gas flow part 15 in the longitudinal direction of the element body 102. For example, as shown in FIG. 2, the first space 93 may exist above the first inner space 20 (above the outer pump electrode 23). Such a position has a high temperature to the extent that the solid electrolyte exhibits oxygen-ion-conductivity during the driving of the gas sensor 100. Therefore, it is considered that when the first space 93 exists in such a position, the effect of reducing thermal shock can more effectively be obtained.

The second space 94 exists in a position farther from the front end of the element body 102 than the first space 93. The second space 94 exists to be in contact with the rear end of the inner layer 91, or exists in a position farther than the rear end of the inner layer 91. The second space 94 may be in contact with the rear end of the inner layer 91 or may exist in a position near the rear end of the inner layer 91. It is considered that in the region of a two-layer structure of the inner layer 91 and the outer layer 92 (the region of the length LA from the front end of the element body 102), thermal stress is more likely to be generated than in the region of only the outer layer 92 (the region of the length LB on the rear end side of the above-described region). When the second space 94 exists near the region of such a two-layer structure, the effect of reducing thermal stress is expected to be obtained. Therefore, the effect of preventing the breakage of internal structure of the porous protective layer 90 caused by the use of the gas sensor 100 is expected to be obtained.

An area ratio (S1/S2) of an area (S1) of the first space 93 to an area (S2) of the second space 94 may preferably be 12 or less, in view of a plane configured with the principal surface of the element body. When the area ratio (S1/S2) is within such a range, it is considered that structural strength of the porous protective layer 90 is further maintained, and therefore the effect of reducing thermal shock can more effectively be maintained over the long-term use of the gas sensor.

The area ratio (S1/S2) of the area (S1) of the first space 93 to the area (S2) of the second space 94 may preferably be more than 1. That is, the area (S1) of the first space 93 may be larger than the area (S2) of the second space 94. When the area ratio (S1/S2) is within such a range, it is considered that the larger thermal insulating space can be provided in a region in which the sensor element 101 has a high temperature, and therefore the effect of reducing thermal shock can more effectively be obtained. The area ratio (S1/S2) may more preferably be 1.1 or more.

As shown in FIG. 4, in this embodiment, the length of each of the first space 93 and the second space 94 in the width direction of the element body 102 is roughly the same as the width of the element body 102. In such a case, the area of the first space 93 and the area of the second space 94 respectively correspond to the length L1 in the longitudinal direction of the first space 93 and the length L2 in the longitudinal direction of the second space 94. Therefore, the area ratio (S1/S2) of the area (S1) of the first space 93 to the area (S2) of the second space 94 roughly corresponds to the ratio (L1/L2) of the length (L1) in the longitudinal direction of the first space 93 to the length (L2) in the longitudinal direction of the second space 94.

In a portion in which the porous protective layer 90 exists on the one principal surface (in this embodiment, the pump surface 102a) of the element body 102 on which the first space 93 and the second space 94 exist, the ratio [(S1+S2)/S] of the total (S1+S2) of the area (S1) of the first space 93 and the area (S2) of the second space 94 to the area (S) of a part in which neither the first space 93 nor the second space 94 exists in the porous protective layer 90 on the one principal surface may preferably be 2.3 or less, in view of a plane configured with the principal surface of the element body 102. Referring to FIG. 3, the area (S) of a part in which neither the first space 93 nor the second space 94 exists refers to the area of the close-contact region in which the inner layer 91 or the element body 102 and the outer layer 92 are in close contact with each other (the total area of the region of the length La1, the region of the length La2, and the region of the length Lb1 in the longitudinal direction). That is, in view of a plane configured with the principal surface of the element body 102, the ratio [(S1+S2)/S] is the ratio of the area (S1+S2) of a region in which a space (the first space 93 and the second space 94) exists in the porous protective layer 90 to the area (S) of the close-contact region. In other words, the ratio [(S1+S2)/S] is a space abundance ratio. When the space abundance ratio [(S1+S2)/S] is within the above-described range, it is considered that adhesive strength between the inner layer 91 or the element body 102 and the outer layer 92 can be ensured, which makes it possible to more effectively prevent the porous protective layer 90 (mainly the outer layer 92) from being peeled off from the element body 102.

The space abundance ratio may be 0.1 or more. When the space abundance ratio is within such a range, it is considered that thermal insulating effect due to a space (the first space 93 and the second space 94) is obtained, and therefore thermal shock to the element body 102 can be reduced when the surface of the sensor element 101, that is, the surface of the porous protective layer 90 is exposed to water. As a result, water resistance of the sensor element 101 is considered to be further improved.

As described above, in this embodiment, the area roughly corresponds to the length in the longitudinal direction of the element body 102. Therefore, referring to FIG. 3 and FIG. 4, the space abundance ratio [(S1+S2)/S] roughly corresponds to the ratio of the total (L1+L2) of the length (L1) of the first space 93 and the length (L2) the second space 94 to the total (La1+La2+Lb1) of lengths of close-contact regions. That is, the space abundance ratio [(S1+S2)/S] roughly corresponds to [(L1+L2)/(La1+La2+Lb1)].

The area of the first space 93 and the area of the second space 94 are not particularly limited and may appropriately be determined in consideration of the above-described area ratio (S1/S2) and the space abundance ratio [(S1++S2)/S]. The area of the first space 93 varies depending on the structure of the sensor element 101 but may be, for example, about 7.8 mm² to 16.5 mm². The area of the second space 94 varies depending on the structure of the sensor element 101 but may be, for example, about 1.5 mm² to 7.2 mm².

The lengths (thicknesses) of the first space 93 and the second space 94 perpendicular to the principal surfaces of the element body 102 are not particularly limited but may be, for example, about 10 μm to 300 μm. It is considered that when the thicknesses are larger, thermal insulating effect tends to improve and when the thicknesses are smaller, the structural strength of the porous protective layer 90 tends to improve.

In this embodiment, the lengths in the width direction of both the first space 93 and the second space 94 are roughly the same as the width of the element body 102 but are not limited thereto. The lengths in the width direction of the first space 93 and the second space 94 may be shorter than the width of the element body 102. Further, the lengths in the width direction of the first space 93 and the second space 94 may be different from each other.

In this embodiment, each of the first space 93 and the second space 94 is one space but is not limited thereto. Two or more first spaces 93 may exist between the inner layer 91 and the outer layer 92. Two or more second spaces 94 may exist between the element body 102 and the outer layer 92 on the principal surface (in this embodiment, the pump surface 102a) on which the first space 93 exists.

In this embodiment, the first space 93 and the second space 94 exist on the pump surface 102a on which the inner layer 91 is formed but are not limited thereto. When the inner layer 91 is formed on both of the principal surfaces, that is, on the pump surface 102a and the heater surface 102b, the first space 93 may exist in at least a part between the inner layer 91 and the outer layer 92 on at least one principal surface of the pump surface 102a and the heater surface 102b. Further, when the first space 93 exists on both of the principal surfaces, that is, on the pump surface 102a and the heater surface 102b, the second space 94 may exist in at least a part between the principal surface and the outer layer 92 on at least one principal surface of the pump surface 102a and the heater surface 102b.

(Protection Cover)

The gas sensor 100 of the present invention includes the above-described sensor element 101 and a protection cover 105 having an internal space for accommodating at least a portion in which the porous protective layer 90 exists on the sensor element 101. Hereinafter, the protection cover 105 in one embodiment of the gas sensor 100 of the present invention will be described.

The gas sensor 100 is configured so that a predetermined range from the front end in the sensor element 101, which includes at least the measurement-object gas flow part 15, is exposed to the measurement-object gas. On the other hand, the gas sensor 100 is configured so that the reference gas (e.g., air) is introduced into the reference gas introduction space 43 from the rear end of the sensor element 101. The sensor element 101 is fixed in a housing (not shown) to maintain airtightness between the front end side and the rear end side of the sensor element 101.

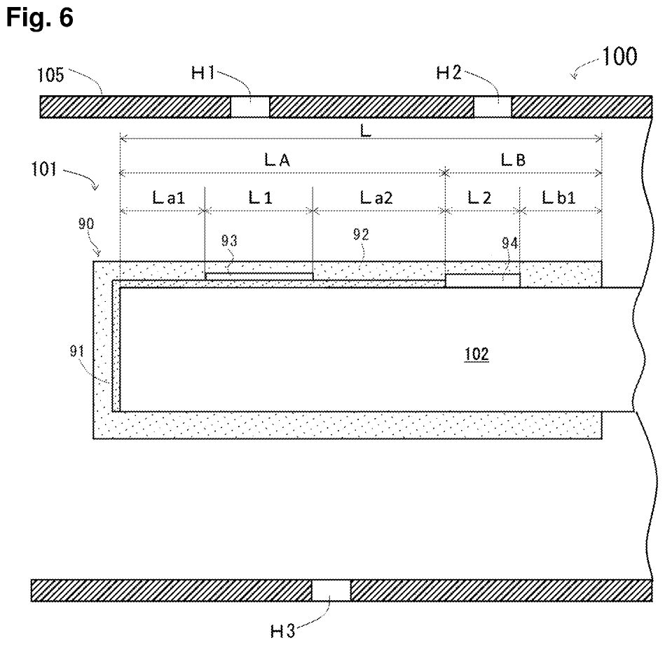

The protection cover 105 covers at least a part of a portion, in which the porous protective layer 90 exists, from the front end of the sensor element 101. FIG. 6 is a schematic sectional view showing the layout of the sensor element 101 and the protection cover 105 in the gas sensor 100 according to this embodiment. In FIG. 6, as in the case of FIG. 3, the components inside the element body 102, such as the measurement-object gas flow part 15 and the electrodes, are not shown.

The protection cover 105 has the function of protecting the sensor element 101 from being cooled by water exposure or a large amount of gas while flowing the measurement-object gas so that the measurement-object gas reaches the sensor element 101. As shown in FIG. 6, the protection cover 105 accommodates the sensor element 101 in the internal space thereof. The protection cover 105 has, for example, a cylindrical shape. The protection cover 105 has vent holes H1, H2, and H3 for flowing the measurement-object gas.

In the protection cover 105, the vent hole H1, H2, or H3 for flowing the measurement-object gas may preferably exist above a portion in which the porous protective layer 90 exists on at least one principal surface of the two principal surfaces (the pump surface 102a and the heater surface 102b) of the element body 102. That is, in view of a plane configured with the principal surface of the element body 102, a vent hole may exist above a portion in which the porous protective layer 90 exists on the pump surface 102a (in FIG. 6, the vent holes H1, H2), and a vent hole may exist above a portion in which the porous protective layer 90 exists on the heater surface 102b (in FIG. 6, the vent hole H3). In other words, a vent hole may exist on a perpendicular line drawn from any position in a portion in which the porous protective layer 90 exists on the pump surface 102a or the heater surface 102b. It is considered that such a structure makes it possible to reduce thermal shock to the element body 102 because even when entering through the vent hole H1, H2, or H3, water attaches to the porous protective layer 90 on the principal surface of the element body 102.

In the protection cover 105, the vent hole H1, or H2 for flowing the measurement-object gas may more preferably exist above a portion in which the porous protective layer 90 exists on the principal surface (in this embodiment, the pump surface 102a) of the element body 102 on which the first space 93 and the second space 94 exist. It is considered that such a structure makes it possible to reduce thermal shock to the element body 102 more because even when entering through the vent hole H1, or H2, water attaches to the porous protective layer 90 in which the thermal insulating spaces (the first space 93 and the second space 94) on the principal surface of the element body 102.

In the protection cover 105, the vent hole H1 for flowing the measurement-object gas may further preferably exist above a portion in which the first space 93 exists on the principal surface (in this embodiment, the pump surface 102a) of the element body 102 on which the first space 93 and the second space 94. It is considered that such a structure makes it possible to further reduce thermal shock to the element body 102 because even when entering through the vent hole H1, water attaches to the porous protective layer 90 at a position in which the first space 93 functioning as the thermal insulating space on the principal surface of the element body 102. Further, the vent hole H2 for flowing the measurement-object gas may exist above a portion in which the second space 94 exists.

In FIG. 6, for the purpose of simplifying illustration, the left side of the protection cover 105 is open. However, the protection cover 105 may actually have a bottomed tubular shape. When the protection cover 105 has a bottomed tubular shape, a vent hole may exist in the bottom surface of the protection cover 105. In FIG. 6, the vent hole H1 above the first space 93 on the pump surface, the vent hole H2 above the second space 94 on the pump surface, and the vent hole H3 above the porous protective layer 90 on the heater surface are shown, but vent holes are not limited thereto. Any one of the vent holes H1, H2, and H3 may exist or two or more of them may exist. The protection cover 105 usually has two or more vent holes to flow the measurement-object gas. A vent hole may exist above the close-contact region, in which neither the first space 93 nor the second space 94 exists, on the pump surface 102a. Each of the vent holes H1, H2, and H3 may include two or more vent holes, and vent holes may exist at two or more kinds of positions.

In FIG. 6, the protection cover 105 is shown as one tubular cover for the purpose of simplifying illustration, but the protection cover 105 is not limited thereto. The protection cover 105 may have such a single structure as shown in FIG. 6 or may have a multiple structure constituted from two or more protection covers. In the case of a protection cover having a multiple structure, a vent hole of the innermost protection cover is more preferably disposed at the above-described position.

As such a protection cover, a known protection cover can be used, such as disclosed in, for example, JP 2016-090569 A and JP 2021-060219 A.

The sensor element 101 and the gas sensor 100 including the sensor element 101 for detecting NOx concentration in a measurement-object gas have been described above as examples of the embodiment according to the present invention, but the present invention is not limited thereto. The present invention may include a sensor element having any structure as long as the object of the present invention can be achieved, that is, the water resistance of sensor element is improved.

In the above embodiment, the gas sensor 100 detects the NOx concentration in a measurement-object gas. However, the target gas to be measured is not limited to NOx. The sensor element of the gas sensor 100 may have a structure using the oxygen-ion-conductive solid electrolyte For example, the target gas to be measured may be oxygen O₂ or an oxide gas other than NOx (e.g., carbon dioxide CO₂, water H₂O). Alternatively, the target gas to be measured may be a non-oxide gas such as ammonia NH₃.

In the gas sensor 100 of the above embodiment, as shown in FIG. 2, the sensor element 101 has a structure in which three internal cavities, the first internal cavity 20, the second internal cavity 40, and the third internal cavity 61 are provided and the inner main pump electrode 22, the auxiliary pump electrode 51, and the measurement electrode 44 are respectively disposed in these internal cavities. However, the structure of the sensor element 101 is not limited thereto. For example, the sensor element 101 may have a structure in which two internal cavities, the first internal cavity 20 and the second internal cavity 40 are provided, the inner main pump electrode 22 is disposed in the first internal cavity 20, and the auxiliary pump electrode 51 and the measurement electrode 44 are disposed in the second internal cavity 40. In this case, for example, a porous protective layer covering the measurement electrode 44 may be formed as a diffusion-rate limiting part between the auxiliary pump electrode 51 and the measurement electrode 44.

Each of the components of the element body 102 other than the internal cavities, such as the measurement-object gas flow part 15 and the electrodes, can also be variously embodied in accordance with the kind of target gas to be measured, the intended use or use environment of the gas sensor and the like.

[Production Method of Sensor Element]

Hereinbelow, an example of a method for producing such a sensor element as described above will be described. In the production method of the sensor element 101, the element body 102 is first produced, and then the porous protective layer 90 is formed on the element body 102 to produce the sensor element 101.

Hereinafter, description is made while taking the case of manufacturing the sensor element 101 composed of six layers shown in FIG. 2 as an example.

(Production of Element Body)

First, a method for producing the element body 102 will be described. Six green sheets containing an oxygen-ion-conductive solid electrolyte such as zirconia (ZrO₂) as a ceramic component are prepared. For manufacturing of the green sheets, a known molding method can be used. The six green sheets may all have the same thickness, or the thickness differs depending on the layer to be formed. In each of the six green sheets, sheet holes or the like for use in positioning at the time of printing or stacking are formed in advance by a known method such as a punching process with a punching apparatus (blank sheet). In the blank sheet for use as the spacer layer 5, penetrating parts such as internal cavities are also formed in the same manner. Also in the remaining layers, necessary penetrating parts are formed in advance.

The blank sheets for use as six layers, namely, the first substrate layer 1, the second substrate layer 2, the third substrate layer 3, the first solid electrolyte layer 4, the spacer layer 5, and the second solid electrolyte layer 6 are subjected to printing of various patterns required for respective layers and drying treatment. For printing of a pattern, a known screen printing technique can be used. Also as the drying treatment, a known drying means can be used.

After completing the printing and drying of diverse patterns for each of the six blank sheets by repeating these steps, contact bonding treatment of stacking the six printed blank sheets in a predetermined order while positioning with the sheet holes and the like, and contact bonding at a predetermined temperature and pressure condition to give a laminate is conducted. The contact bonding treatment is conducted by heating and pressurizing with a known laminator such as a hydraulic press. While the temperature, the pressure and the time of heating and pressurizing depend on the laminator being used, they may be appropriately determined to achieve excellent lamination.

The obtained laminate includes a plurality of element bodies 102. The laminate is cut into units of the element body 102. The cut laminate is fired at a predetermined firing temperature to obtain the element body 102. The firing temperature may be such a temperature that the solid electrolyte forming the base part 103 of the sensor element 101 is sintered to become a dense product, and electrodes or the like maintains desired porosity. The firing is conducted, for example, at a firing temperature of about 1300 to 1500° C.

(Production of Protective Layer)

Next, a method for forming the porous protective layer 90 (the outer layer 92 and the inner layer 91), the first space 93, and the second space 94 on the element body 102 will be described.

First, a coating layer that should serve as the inner layer 91 is formed on the front end surface 102e and the pump surface 102a in a predetermined pattern. The coating layer is formed by using a paste that is prepared so that a desired inner layer 91 can be obtained after degreasing in the subsequent step. The paste for forming the inner layer 91 is prepared by blending a raw material powder (in this embodiment, an alumina powder) composed of the material of the inner layer 91, and an organic binder, an organic solvent, etc. The paste may be prepared by adding a pore forming material for forming pores, as needed. As the pore forming material, the same material as an evaporative agent described below can be used. The coating layer can be formed by, for example, well-known screen printing, gravure printing, or ink-jet printing.

Then, an evaporative agent that will disappear by degreasing is applied onto a position, in which the first space 93 is to be formed, on the coating layer that should serve as the inner layer 91 on the pump surface 102a. Further, an evaporative agent paste that will disappear by degreasing is applied onto a position in which the second space 94 is to be formed. The evaporative agent paste is prepared by mixing an evaporative agent, an organic binder, and an organic solvent and the like. The evaporative agent is an organic or inorganic material that will disappear by degreasing in the subsequent step. Examples of the evaporative agent that can be used include a xanthine derivative such as theobromine, an organic resin material such as an acrylic resin, and an inorganic material such as carbon. The evaporative agent can be applied by, for example, well-known screen printing, gravure printing, or ink-jet printing.

Then, a layer that should serve as the outer layer 92 is formed. The layer that should serve as the outer layer 92 can be formed using various methods such as screen printing, dipping, and gel casting. Alternatively, the outer layer 92 may be formed by plasma spraying.

Finally, the step of subjecting the layers that should serve as the inner layer 91, the first space 93, the second space 94, and the outer layer 92 to heat treatment is performed to form the porous protective layer 90 (the inner layer 91 and the outer layer 92) comprising a porous material, the first space 93, and the second space 94. That is, the step of degreasing is performed at a predetermined degreasing temperature. The degreasing temperature is not particularly limited as long as all the evaporative agent in the coating layer that should serve as the first space 93 and the coating layer that should serve as the second space 94. And, the degreasing temperature is not particularly limited as long as all organic components in the printed films of the inner layer 91 and the outer layer 92 (in the case where the outer layer 92 is formed by plasma spraying, the inner layer 91) can disappear and the porous structure of the porous protective layer 90 can be maintained. The degreasing temperature may be lower than the firing temperature of the element body 102. For example, the coating layers are degreased at a degreasing temperature of about 400 to 900° C.

The obtained sensor element 101 is housed in a predetermined housing and incorporated in the gas sensor 100 in such a manner that the front end portion of the sensor element 101 comes into contact with a measurement-object gas and the rear end portion of the sensor element 101 comes into contact with a reference gas. It is to be noted that a protection cover 105 is attached to surround the front end portion of the sensor element 101.

### EXAMPLES

Hereinafter, the case of actually manufacturing a sensor element and conducting a test is described as Examples. The present invention is not limited to the following Examples.

[1. Evaluation of Water Resistance]

### Production of Examples 1 to 11

The sensor elements of Examples 1 to 11 were produced in accordance with the above-described production method of the sensor element 101. Specifically, an element body 102 was produced which had a longitudinal length of 67.5 mm, a horizontal width of 4.25 mm, and a vertical thickness of 1.45 mm. Then, a porous protective layer 90, a first space 93, and a second space 94 were formed so that the position and the area of each of the first space 93 and the second space 94 satisfied the following conditions.

In Examples 1 to 11, a principal surface on which the first space 93 and the second space 94 existed was a top pump surface (Examples 1 to 8) or a bottom heater surface (Examples 9 to 11). The area ratio (S1/S2) of the area (S1) of the first space 93 to the area (S2) of the second space 94 was set to 1.1 (Example 1), 1.3 (Example 2), 2 (Example 3), 3 (Examples 4 and 10), 7 (Example 5), 10 (Examples 6 and 11), 12 (Example 7), 15 (Example 8), or 1 (Example 9). In all of Examples 1 to 11, the space abundance ratio [(S1+S2)/S] of the total (S1+S2) of the area (S1) of the first space 93 and the area (S2) of the second space 94 to the area (S) of a close-contact region in which neither the first space 93 nor the second space 94 existed was set to 1.2.

In Examples 1 to 8, an inner layer 91 was formed on the front end surface of the element body 102 and on the pump surface in a region of a length LA from the front end of the element body 102. In Examples 9 to 11, an inner layer 91 was formed on the front end surface of the element body 102 and on the heater surface in a region of a length LA in the longitudinal direction from the front end of the element body 102. In all of Examples 1 to 11, the length (LA) in the longitudinal direction of the inner layer 91 was set to 7 mm and the thickness of the inner layer 91 was set to 200 The porosity of the inner layer 91 was set to 45 vol %. The inner layer 91 was formed across the entire width of the principal surface (the pump surface 102a or the heater surface 102b) and in the beveled portions of both of the corners, throughout the entire length (LA) in the longitudinal direction.

In all of Examples 1 to 11, an outer layer 92 was formed to cover the inner layer 91 and the entire surface of a region of a length L in the longitudinal direction from the front end of the element body 102. The length (L) in the longitudinal direction of the outer layer 92 was set to 12 mm and the thickness of the whole porous protective layer 90 was set to 800 The porosity of the outer layer 92 was set to 45 vol %.

In all of Examples 1 to 11, the length in the width direction of each of the first space 93 and the second space 94 was set to be the same as the width of the element body 102. Therefore, the areas of the first space 93 and the second space 94 almost correspond to the lengths in the longitudinal direction of the first space 93 and the second space 94. Referring to FIG. 3, the total of the length (L1) of the first space 93 and the length (L2) of the second space 94 in the longitudinal direction was set to 6.5 mm. In each of Examples 1 to 11, the length L1 and the length L2 were determined so that a predetermined area ratio (S1/S2), that is, a predetermined length ratio (L1/L2) was achieved. Further, referring to FIG. 3, the first space 93 and the second space 94 were disposed so that the space abundance ratio [(S1+S2)/S], that is, [(L1+L2)/(La1+La2+Lb1)] was 1.2 based on the lengths in the longitudinal direction. The thickness of the first space 93 was set to 50 μm and the thickness of the second space 94 was set to 120 μm.

In all of Examples 1 to 11, the first space 93 was disposed so that the middle point thereof in the longitudinal direction corresponded to the middle point of the outer electrode 23. In all of Examples 1 to 11, the second space 94 was disposed posterior to the rear end of the inner layer 91 to have a length of L2.

### Production of Comparative Example 1

A sensor element of Comparative Example 1 was produced in the same manner as in Examples 1 to 8 except that the first space 93 and the second space 94 were not formed. Specifically, in Comparative Example 1, an inner layer 91 was formed on the front end surface of the element body 102 and on the pump surface in a region of a length LA from the front end of the element body 102. Further, an outer layer 92 was formed to cover the inner layer 91 and the entire surface of a region of a length L in the longitudinal direction from the front end of the element body 102.

(Evaluation of Water Resistance)

The sensor elements 101 of Examples 1 to 11 and Comparative Example 1 were subjected to evaluation of the performance of the porous protective layer 90 (water resistance of the sensor element 101). Specifically, initially, the heater 72 was energized, the temperature was set at 800° C., and the sensor element 101 was heated. In this state, the main pump cell 21, the auxiliary pump cell 50, the oxygen-partial-pressure detection sensor cell 80 for main pump control, the oxygen-partial-pressure detection sensor cell 81 for auxiliary pump control, and the like were actuated in an air atmosphere and the oxygen concentration in the first internal cavity 20 was controlled so as to be maintained at a predetermined constant value. Then, after waiting stabilization of the pump current Ip0, water was dropped onto the porous protective layer 90 on the principal surface (the pump surface or the heater surface) of the element body 102 on which the first space 93 and the second space 94. Then, presence or absence of a crack in the sensor element 101 was determined on the basis of whether or not the pump current Ip0 increased by 5% or more. In Comparative Example 1, water was dropped onto the porous protective layer 90 on the pump surface. If cracking occurs in the sensor element 101 because of thermal shock due to a water droplet, oxygen passes through the cracked portion and flows into the first internal cavity 20 easily, so that the value of the pump current Ip0 increases. Therefore, in the case where the pump current Ip0 was increased by 5% or more, it was judged that cracking occurred in the sensor element 101 because of the water droplet.

Further, a plurality of tests was performed by gradually increasing the amount of water droplets to 60 μL to determine the amount of water droplets at the time when the pump current Ip0 increased by 5% or more (when cracking was suspected to occur in the sensor element 101). Five sensor elements 101 of each of Examples 1 to 11 and Comparative Example 1 were prepared, and the average of the amounts of water droplets determined for the five sensor elements 101 was determined for each of Examples 1 to 11 and Comparative Example 1. The average of the amounts of water droplets was evaluated according to the following criteria.

A: No increase in pump Ip0 was observed with the water droplets amount of 40 μL or more and 60 μL or less.

B: Increase in pump Ip0 was observed with the water droplets amount of 10 μL or more and less than 40 μL.

C: Increase in pump Ip0 was observed with the water droplets amount of less than 10 μL.

The evaluation results of water resistance are shown in Table 1.

TABLE 1

| | | | Space | |
|---|---|---|---|---|
| | Surface in which | | abundance ratio | |
| | Inner layer 91, | Area | [(S1 + S2)/ | Wa- |
| | First space 93, | ratio | S] = [(L1 + | ter |
| | and Second space | (S1/S2) = | L2)/(La1 + | resis- |
| | 94 were formed | (L1/L2) | La2 + Lb1)] | tance |
| Example 1 | Pump surface 102a | 1.1 | 1.2 | B |
| Example 2 | Pump surface 102a | 1.3 | 1.2 | A |
| Example 3 | Pump surface 102a | 2 | 1.2 | A |
| Example 4 | Pump surface 102a | 3 | 1.2 | A |
| Example 5 | Pump surface 102a | 7 | 1.2 | A |
| Example 6 | Pump surface 102a | 10 | 1.2 | A |
| Example 7 | Pump surface 102a | 12 | 1.2 | B |
| Example 8 | Pump surface 102a | 15 | 1.2 | C |
| Example 9 | Heater surface 102b | 1 | 1.2 | A |
| Example 10 | Heater surface 102b | 3 | 1.2 | A |
| Example 11 | Heater surface 102b | 10 | 1.2 | A |
| Comparative | Inner layer 91 existed | — | — | C |
| Example 1 | on Pump surface 102a, | | | |
| | but no first space 93 | | | |
| | and no second space | | | |
| | 94 | | | |

As shown in Table 1, all of Examples 1 to 11 were confirmed to have water resistance comparable to or higher than Comparative Example 1. As can be seen from the results of Examples 1 to 8 in which the inner layer 91, the first space 93, and the second space 94 are disposed on the pump surface 102a, water resistance tends to further improve as the space area ratio (S1/S2) increases. On the other hand, Example 8 having the largest space area ratio (S1/S2) had water resistance comparable to Comparative Example 1. This is because the outer layer 92 above the first space 93 was peeled off. Therefore, it was confirmed that water resistance was improved due to the existence of the first space 93 and the second space 94.

[2. Evaluation of Peeling Resistance]

### Production of Examples 12 to 20

Sensor elements of Examples 12 to 20 were produced in accordance with the above-described production method of the sensor element 101. A porous protective layer 90, a first space 93, and a second space 94 were formed so that the position and the area of each of the first space 93 and the second space 94 satisfied the following conditions.

In all of Examples 12 to 20, a principal surface on which the first space 93 and the second space 94 existed was a top pump surface. In all of Examples 12 to 20, the area ratio (S1/S2) of the area (S1) of the first space 93 to the area (S2) of the second space 94 was set to 1.3. In Examples 12 to 20, the space abundance ratio [(S1+S2)/S] of the total (S1+S2) of the area (S1) of the first space 93 and the area (S2) of the second space 94 to the area (S) of a close-contact region in which neither the first space 93 nor the second space 94 existed was set to 0.1 (Example 12), 0.4 (Example 13), 0.7 (Example 14), 1 (Example 15), 1.2 (Example 16), 1.5 (Example 17), 2.3 (Example 18), 2.5 (Example 19), or 3 (Example 20). The sensor element 101 was produced in the same manner as in Examples 1 to 11 except for the above conditions.

### Comparative Example 1

As Comparative Example 1, the same Comparative Example 1 as in the case of [1. Evaluation of water resistance] was used.

(Evaluation of Peeling Resistance)

The sensor elements 101 of Examples 12 to 20 and Comparative Example 1 were subjected to evaluation of the peeling resistance of the porous protective layer 90. Specifically, gas sensors 100 of Examples 12 to 20 and Comparative Example 1 respectively including the sensor elements 101 of Examples 12 to 20 and Comparative Example 1 were produced. The number of gas sensors 100 produced in each of Examples 12 to 20 and Comparative Example 1 was 5. A hot vibration test was performed under the following conditions in a state where each of the gas sensors 100 was attached to the exhaust pipe of a propane burner placed in a vibration tester.

Gas temperature: 850° C.;

Gas air ratio λ:1.05;

Vibration conditions: sweeping for 30 minutes at 50 Hz, 100 Hz, 150 Hz, and 250 Hz in this order;

Acceleration: 30 G, 40 G, and 50 G; and

Test time: 150 hours.

The sensor element 101 was taken out of each of the gas sensors 100 after the hot vibration test. The porous protective layer 90 of each of the five sensor elements 101 of each of Examples 12 to 20 and Comparative Example 1 after the hot vibration test was observed visually, and the peeling resistance of the porous protective layer 90 was evaluated according to the following criteria.

A: In all of the five sensor elements, no abnormality occurred in the porous protective layer 90.

B: In at least one of the five sensor elements, peeling or dropping off of the porous protective layer 90 did not occur but cracking was visually observed.

C: In at least one of the five sensor elements, peeling or dropping off of the porous protective layer 90 occurred.

The evaluation results of peeling resistance are shown in Table 2.

TABLE 2

| | | | Space | |
|---|---|---|---|---|
| | Surface in which | | abundance ratio | |
| | Inner layer 91, | Area | [(S1 + S2)/ | Peel- |
| | First space 93, | ratio | S] = [(L1 + | ing |
| | and Second space | (S1/S2) = | L2)/(La1 + | resis- |
| | 94 were formed | (L1/L2) | La2 + Lb1)] | tance |
| Example 12 | Pump surface 102a | 1.3 | 0.1 | A |
| Example 13 | Pump surface 102a | 1.3 | 0.4 | A |
| Example 14 | Pump surface 102a | 1.3 | 0.7 | A |
| Example 15 | Pump surface 102a | 1.3 | 1 | A |
| Example 16 | Pump surface 102a | 1.3 | 1.2 | A |
| Example 17 | Pump surface 102a | 1.3 | 1.5 | A |
| Example 18 | Pump surface 102a | 1.3 | 2.3 | A |
| Example 19 | Pump surface 102a | 1.3 | 2.5 | B |
| Example 20 | Pump surface 102a | 1.3 | 3 | C |
| Comparative | Inner layer 91 existed | — | — | A |
| Example 1 | on Pump surface 102a, | | | |
| | but no first space 93 | | | |
| | and no second space | | | |
| | 94 | | | |

As shown in Table 2, it was confirmed that Examples 12 to 18 in which the first space 93 and the second space 94 existed could maintain peeling resistance comparable to Comparative Example 1. The hot vibration test is an accelerated test performed under conditions severer than conditions of actual use, and therefore even when evaluated as B or C in the hot vibration test, the sensor element can actually be used. A larger space abundance ratio, that is, a smaller area of the close-contact region may be disadvantageous in terms of the structural strength of the porous protective layer 90 but improves thermal insulating effect obtained by the first space 93 and the second space 94. The first space 93 and the second space 94 may be disposed in consideration of both of peeling resistance and water exposure resistance in accordance with the use environment and required performance of the gas sensor 100.

As has been described above, according to the present invention, thermal insulating effect can be obtained by the first space 93 and the second space 94 while adhesive strength can be maintained by the close-contact region. Therefore, even when water is splashed on the sensor element 101, thermal shock to the element body 102 can be reduced. As a result, higher water resistance can be achieved.

Explanation of reference signs in the Drawings

1: first substrate layer; 2: second substrate layer; 3: third substrate layer; 4: first solid electrolyte layer; 5: spacer layer; 6: second solid electrolyte layer; 10: gas inlet; 11: first diffusion-rate limiting part; 12: buffer space; 13: second diffusion-rate limiting part; 15: measurement-object gas flow part; 20: first internal cavity; 21: main pump cell; 22: inner main pump electrode 22; 22a: ceiling electrode portion (of the inner main pump electrode); 22b: bottom electrode portion (of the inner main pump electrode); 23: outer pump electrode; 24: variable power supply (of the main pump cell); 30: third diffusion-rate limiting part; 40: second internal cavity; 41: measurement pump cell; 42: reference electrode; 43: reference gas introduction space; 44: measurement electrode; 46: variable power supply (of the measurement pump cell); 48: air introduction layer; 50: auxiliary pump cell; 51: auxiliary pump electrode; 51a: ceiling electrode portion (of the auxiliary pump electrode); 51b: bottom electrode portion (of the auxiliary pump electrode); 52: variable power supply (of the auxiliary pump cell); 60: fourth diffusion-rate limiting part; 61: third internal cavity; 70: heater part; 71: heater electrode; 72: heater; 73: through hole; 74: heater insulating layer; 75: pressure relief vent; 76: heater lead; 80: oxygen-partial-pressure detection sensor cell for main pump control; 81: oxygen-partial-pressure detection sensor cell for auxiliary pump control; 82: oxygen-partial-pressure detection sensor cell for measurement pump control; 83: sensor cell; 90, 90a to 90e: porous protective layer; 91: inner layer; 92: outer layer; 93: first space; 94: second space; 100: gas sensor; 101: sensor element; 102, 102a to 102f: element body; 103: base part; and 105: protection cover.

What is claimed is:

1. A sensor element for detecting a target gas to be measured in a measurement-object gas, the sensor element comprising:
an element body that includes a base part in an elongated plate shape, including an oxygen-ion-conductive solid electrolyte layer, and a measurement-object gas flow part formed on a side of one end in a longitudinal direction of the base part; and
a porous protective layer that is formed from the one end in the longitudinal direction of the base part and covers at least a part in the longitudinal direction of a surface of the element body, wherein
the protective layer comprises:
an inner layer formed on an end surface of the one end in the longitudinal direction of the base part, and on at least one principal surface of two principal surfaces of the element body in a region of a predetermined length in the longitudinal direction from the one end in the longitudinal direction; and
an outer layer covering a surface of the inner layer, and a surface of a region in which the inner layer is not formed on the at least part of the surface of the element body, and
wherein, on one principal surface in a region in which the inner layer is formed, a first space exists in at least a part between the inner layer and the outer layer, and
on said one principal surface in a region in which the inner layer is not formed on said one principal surface of the element body on which the first space exists, a second space exists in at least a part between said one principal surface and the outer layer.

2. The sensor element according to claim 1, wherein an area ratio of an area of the first space to an area of the second space is 12 or less, in view of a plane configured with the principal surface of the element body.

3. The sensor element according to claim 2, wherein the area ratio is more than 1.

4. The sensor element according to claim 2, wherein the area ratio is 1.1 or more and 12 or less.

5. The sensor element according to claim 1, wherein, in a portion in which the protective layer exists on said one principal surface of the element body on which the first space and the second space exist, a ratio of a total area of the first space and the second space to an area of a part in which neither the first space nor the second space exists in the protective layer on said one principal surface is 2.3 or less, in view of a plane configured with the principal surface of the element body.

6. The sensor element according to claim 5, wherein the ratio is 0.1 or more and 2.3 or less.

7. The sensor element according to claim 1, wherein a porosity of the outer layer in the protective layer is larger than a porosity of the inner layer in the protective layer.

8. The sensor element according to claim 1, wherein the element body comprises:
an inner electrode disposed on an inner surface of the measurement-object gas flow part; and
an outer electrode disposed corresponding to the inner electrode on one principal surface of the two principal surfaces of the element body, and
the inner layer, the first space and the second space exist on said one principal surface on which the outer electrode is disposed.

9. A gas sensor for detecting a target gas to be measured in a measurement-object gas, the gas sensor comprising a sensor element according to claim 1 and a protection cover having an internal space for accommodating at least a portion in which the protective layer exists on the sensor element, wherein
the protection cover has a vent hole though which a measurement-object gas flows above a portion in which the protective layer exists on at least one principal surface of the two principal surfaces of the element body.

10. The gas sensor according to claim 9, wherein the protection cover has the vent hole above a portion in which the protective layer exists on said one principal surface of the element body on which the first space and the second space exist.

11. The gas sensor according to claim 9, wherein the protection cover has the vent hole above a portion in which the first space exists on said one principal surface of the element body on which the first space and the second space exist.
